(19) United States
(12) Patent Application Publication
(10) Pub. No.: US 2007/0163428 A1
(43) Pub. Date: Jul. 19, 2007

(54) SYSTEM AND METHOD FOR NETWORK COMMUNICATION OF MUSIC DATA

(76) Inventor: Hal C. Salter, Seffner, FL (US)

Correspondence Address: ADVANTIA LAW GROUP, 9035 SOUTH 1300 EAST, SUITE 200, SANDY, UT, 84094, US

(21) Appl. No.: 11/622,987

(22) Filed: Jan. 12, 2007

Related U.S. Application Data
(60) Provisional application No. 60/758,885, filed on Jan. 13, 2006.

(51) Int. Cl. G10H 1/40; G10H 7/00

(52) U.S. Cl. 84/611

(57) ABSTRACT

A system, computer readable storage medium, and method for communicating musical data over a network, comprising: connecting one or more player modules to a network; providing an unassigned channel of prerecorded music data; providing an assigned channel of prerecorded music data; displaying the assigned channel; playing the unassigned channel while not playing the assigned channel; converting musical performance to music performance data; evaluating the music performance data in regard to the assigned channel; and simultaneously delivering a representation of the evaluation over the network. There may also be a graphical user interface, including a virtual instrument positioned substantially at a top portion of the graphical interface. Additionally, included are pluralities of musical notes in sequence, having a rhythmic pattern, each note being represented by a game object, wherein the game objects are directed upward, in substantially straight trajectories, toward the virtual keys on the virtual musical instrument corresponding to the musical notes.

### CROSS-REFERENCE TO RELATED APPLICATIONS

This invention claims priority, under 35 U.S.C. § 120, to the U.S. Provisional Patent Application No. 60/758,885 filed on Jan. 13, 2006 which is incorporated by reference herein.

### BACKGROUND OF THE INVENTION

1. Field of the Invention

The present invention relates to communication of music data over a network, specifically to a system and method for multiplayer communication of music data over a network.

2. Description of the Related Art

In the related art, a variety of communication systems and methods are often used to communicate and send music information via a network. With advances in internet and network technology the type, form, amount, and function of music data communicable over a network has greatly increased. While transferring music data such as songs and albums in the form of MP3, m4p, and AAC files is more widely known; networking technology and software has recently enabled musical instruments and/or music data recorded via musical instruments to be communicated via networks and the internet.

In an effort to more quickly form composite musical works, program servers have been developed which interface with the Internet and allow multiple musicians at different locations to use the Internet to send a Musical Instrument Digital Interface (or MIDI) audio streams over the Internet to the server, which mixes the audio sources using an MIDI merge function and feeds the merged MIDI signal back to participating musicians. However, this system, too, does not operate in real time, and cannot provide feedback to the musicians/vocalists while they are playing their instruments and/or singing their vocal part.

MIDI defines an interface for exchanging information between electronic musical instruments, computers, sequencers, lighting controllers, mixers, and tape recorders as discussed in MIDI Manufacturers Association publication entitled, MIDI 1.0 Detailed Specification (1990). MIDI is extensively used both in the recording studio and in live performances and has had enormous impact in the areas of studio recording and automated control, audio video production and composition. By itself and in conjunction with other media, MIDI plays an integral role in the application of computers to multimedia applications. In comparison to digital audio, MIDI files take up much less space, and the information is symbolic for convenient manipulation and viewing. For example, a typical three minute MIDI file may require 30 to 60 Kilobytes on a disk, whereas a CD quality stereo audio file requires about two hundred Kilobytes per second or 36 Megabytes for three minutes. MIDI data may appear as musical notation, graphical piano-roll, or lists of messages suitable for editing and reassignment to different instruments. General MIDI has standardized instrument assignments to greatly motivate the multimedia title producer. MIDI input and output ports are used to route time-stamped MIDI packets from one media component to another. MIDI ports act as mailboxes for the communication of MIDI packets across address spaces. Many interesting MIDI applications can be created by connecting media components that contain MIDI ports. For example, a MIDI player and a MIDI interface can be used to play a music device, like an electronic player piano, connected to a computer. MIDI packets are sent from the MIDI player to the MIDI interface. The MIDI interface converts the MIDI packets to MIDI data that is sent to the player instrument piano for playback.

Additionally, certain MIDI files and songs are already broken up into ‘tracks’ or channels which may be the equivalent of voice, or orchestral parts, or simply the treble and bass clefs. Players are able to select which tracks or combination of tracks are to be included in the game, again this will affect the score as to what percentage of the total song these tracks include. The selection of songs, then number or choice of tracks, and then tempo are the principle ways that the player can determine the level of the game, and the focus of the repetition. This is further taught in U.S. patent application No. 20040137984, which is incorporated by reference herein.

Currently, there is a variety of systems and methods which enable multiple players to not only communicate musical instrument data over a network, but also to compete against one another in a multiplayer format. These systems and methods however, provide inadequate feedback as to the performance of the multiple players. With the current systems and methods a player is not updated and kept informed of the performance of the other players.

Further, during the course of multiplayer competitions and collaborations, the performance of one individual may negatively affect the performance of another individual in the multiplayer group. For example, the performance audio data associated with and/or played by one player may interrupt or confuse another player in the group. In another example, one or more players may have different connection speeds; thereby requiring buffering software which can limit participants, cause delays, slow down, and negatively affect a multiplayer group's play.

Additionally, many of the current systems do not provide adequate musical instruction for those novice or beginner musicians; thereby limiting the number and/or player able to play. For example, if an experienced guitar player wishes to play with his friends, he or she may be limited to playing with only those friends who are experienced musicians. Those inexperienced friends or players would either not have the capability to play and participate or, the inexperience participation may negatively affect and/or interrupt the experienced player (s).

Some improvements have been made in the field. Examples include, but are not limited to, the references described below. Which references are incorporated by reference herein:

U.S. Pat. No. 6,342,665, issued to Okita et al., discloses a drum rhythm game apparatus and a guitar rhythm game apparatus each includes a staging operating unit. Playing progression information, which includes sector numbers, is transferred between the drum rhythm game apparatus and the guitar rhythm game apparatus, thereby enabling staging operation to be implemented from each of the staging operating units while synchronizing the visual staging instructions provided to players of the game for the background music piece to be played at both the drum rhythm game apparatus and the guitar rhythm game apparatus.

U.S. Pat. No. 6,898,637, issued to Curtin, discloses an internet based music collaboration system in which musicians and/or vocalists at client locations transmit audio signals to a server location where the audio signals are combined into a composite musical work and sent back to each of the client locations. The work may be sent back as a composite musical signal which is the concatenation of all individual audio signals or as a mix of audio signals.

U.S. Pat. No. 6,653,545, issued to Redmann et al., discloses a method and apparatus to permit real time, distributed performance by multiple musicians at remote locations. The latency of the communication channel is transferred to the behavior of the local instrument so that a natural accommodation is made by the musician. This allows musical events that actually occur simultaneously at remote locations to be played together at each location, though not necessarily simultaneously at all locations. This allows locations having low latency connections to retain some of their advantage. The amount of induced latency can be overridden by each musician.

U.S. Pat. No. 6,438,611, issued to Hara et al, discloses a network system for ensemble performance by remote terminals, wherein in a network performance system involving a plurality of performance apparatuses, each performance apparatus stores phrase performance information of a plurality of performance parts, and each performance apparatus is allocated with one of the performance parts to conduct an ensemble performance composed of the plurality of the performance parts. A server apparatus is connected to each of the performance apparatuses via a network. Each of the performance apparatuses is manually operable to input operational information relating to the performance part allocated thereto, and transmits the inputted operational information to the server apparatus via the network. The server apparatus delivers the operational information transmitted by each of the performance apparatuses to other of the performance apparatuses via the network. Each of the performance apparatuses receives the operational information relating to other performance parts allocated to other of the performance apparatuses from the server apparatus via the network, and reproduces the phrase performance information of the performance part allocated thereto in response to the inputted operational information and concurrently reproduces the phrase information of other performance parts allocated to other of the performance apparatuses in response to the received operational information to thereby conduct the ensemble performance composed of the plurality of the performance parts.

U.S. Pat. No. 6,482,087, issued to Egozy et al, discloses a method for providing real-time musical interaction among a plurality of players connected via a network includes the steps of analyzing local player's musical performance to extract emulation data that represents the musical performance; transmitting emulation data to remote players over a network; receiving emulation data from remote players over the network; and using the emulation data to emulate the remote player's musical performance by locally generating approximations of the performances.

U.S. Pat. No. 6,821,203, issued to Suga et al, discloses an apparatus to enable mark-up (i.e., scoring) of improvised (i.e., ad-libbed) musical performance and enable a player to enjoy performance with a degree of freedom in accordance with a performance instruction, a CPU (10) marks up improvised musical performance provided by a player using an actual keyboard (90) (step S920).

U.S. Pat. No. 6,924,425, issued to Naples et al, discloses a computer-readable medium data structure that encodes an audio performance for interactive playback. The data structure includes a virtual instrument pool, which encodes an interactive part of the audio performance. Audio content of the interactive part is encoded at least in a sequence of synthesizer control data. Each datum in the synthesizer control data specifies a digital sample of the audio content to be played back. The data structure also includes a global accompaniment pool, which encodes non-interactive portions of the audio performance. The global accompaniment pool includes timing information to synchronize the playback of the audio performance.

U.S. Pat. No. 6,067,566, issued to Moline, discloses a technique for distributing MIDI tracks across a network using non-real-time protocols such as TCP/IP. Included are techniques for producing MIDI tracks from MIDI streams as the MIDI streams are themselves produced and distributing the MIDI tracks across the network, techniques for dealing with the varying delays involved in distributing the tracks using non-real-time protocols, and techniques for saving the controller state of a MIDI track so that a user may begin playing the track at any point during its distribution across the network. Network services based on these techniques include distribution of continuous tracks of MIDI music for applications such as background music, distribution of live recitals via the network, and participatory music making on the network ranging from permitting the user to “play along” through network jam sessions to using the network as a distributed recording studio.

The inventions heretofore known suffer from a number of disadvantages which include: inadequacy of an individual's performance feedback; inadequacy of a group's performance feedback; inadequacy of musical instruction for novice and/or non-musically inclined individuals; not allowing for real-time interaction between individual players; requiring the use of complicated software components and/or buffering systems; and/or so forth.

What is needed is a system and method for network communication of the music data that solves one or more of the problems described herein and/or one or more problems that may come to the attention of one skilled in the art upon becoming familiar with this specification.

### SUMMARY OF THE INVENTION

The present invention has been developed in response to the present state of the art, and in particular, in response to the problems and needs in the art that have not yet been fully solved by currently available systems and methods for network communication of music data. Accordingly, the present invention has been developed to provide an system and method for network of communication of music data that provides real-time, simultaneous feedback on the performance of some or all of the individual players in a multiplayer group; allows for visual, easy to follow instructions for novice and/or non-musical individuals, and provides a multiplayer environment with limited and/or no negative interference from other individuals.

In one embodiment, there is a system for communicating music data over a network, comprising: (a) a network module; a control module in communication with the network module; (b) a music data storage module in communication with the control module, and/or configured to store music data, the music data storage module including: an assigned channel, and/or an unassigned channel; and/or (c) a first player module in communication with the network module. The first player module may include: an audio module in communication with the data storage module, and/or configured to broadcast audio, wherein the audio module in a first mode plays the unassigned channel and does not play the assigned channels; a display module in communication with the data storage module, and/or configured to visually display data, and/or wherein the display module displays the assigned channel; an evaluation module in communication with the display module, and/or configured to evaluate a performance; and/or a performance module, in communication with the evaluation module, and/or configured to convert a musical performance to musical performance data. The system may further include a second player module in communication with the network module.

In another embodiment of the invention, the system may further comprise a second mode, wherein the audio module plays simultaneously a recorded performance from the first player module and the second player module. Additionally, the system may include a third mode, wherein the display module displays evaluation data associated with the first player module. Further, the display module may simultaneously display evaluation data associated with the first player module and evaluation data associated with the second player module during the first mode.

In yet another embodiment, the system may further include a display module further comprising: (a) a graphical user interface module, having a first position, including a virtual musical instrument positioned substantially at a top portion of the interface, the virtual musical instrument having a plurality of keys, each key corresponding to a key on the performance module; and/or (b) a game object, wherein the game object includes a plurality of musical notes in sequence having a rhythmic pattern associated with musical performance data, and/or wherein the game object is directed upward on the graphical user interface module, in substantially straight trajectories, toward virtual keys on the virtual musical instrument. Additionally, the game objects may be collided with the corresponding keys according to the rhythmic pattern of the musical performance data, and/or the first player module may be awarded a value based upon the first player module striking the corresponding key on the musical performance module approximately simultaneously as the game object collides with the virtual keys.

In yet another embodiment, the graphical user interface module may further comprise a series of visible staff lines, wherein the visible staff lines correspond to the substantially straight trajectories of the game objects, such that the game objects travel along the lines until the game objects collide with the corresponding virtual keys.

In still another embodiment, there is a method and a computer readable storage medium comprising computer readable program code configured to execute on a processor for communicating musical data over a network. The program code may be configured to and/or execute a method for: (a) connecting a first player module to a network; providing an unassigned channel of prerecorded music data; (b) providing an assigned channel of prerecorded music data; (c) displaying the assigned channel; playing the unassigned channel while not playing the assigned channel; (d) converting musical performance to music performance data; (e) evaluating the music performance data in regard to the assigned channel; and/or (f) delivering a representation of the evaluation over the network.

In yet another embodiment, the program code may be further configured to and/or execute a method for evaluating music data, wherein evaluating music data includes: recording a performance channel; and/or matching units of the performance channel to units of the assigned channel.

In another embodiment, the program code may be further configured to and/or execute a method for displaying evaluation data associated with the first player module. Further, the evaluation data associated with a first player module and a second player module may be simultaneously visually displayed during the first mode. The program code may also be configured to and/or execute a method for simultaneously playing back a recorded performance data channel from the first player module and a performance data channel from a second player module.

In still another embodiment, the program code may be configured to and/or execute a method for: generating a graphical user interface. The graphical user interface may include: (a) a virtual instrument positioned substantially at a top portion of the graphical interface, wherein the virtual musical instrument includes a plurality of virtual keys, each key corresponding to a key on the performance module; (b) incorporating a music file into the graphical user interface, wherein the music file contains data corresponding to an arrangement of a plurality of musical notes in sequence, having a rhythmic pattern, each note being represented by a game object; (c) directing the game objects upward, in substantially straight trajectories, toward the virtual keys on the virtual musical instrument corresponding to the musical notes; (d) colliding the game objects with the corresponding keys according to the rhythmic pattern of the arrangement; and/or (d) awarding a value to the first player module based upon the first player module striking a corresponding key on the musical performance module approximately simultaneously with the collisions. The graphical user interface may additionally introduce a series of visible staff lines defining spaces, wherein the lines and spaces correspond to the substantially straight trajectories along which the game objects travel toward the virtual musical instrument, such that the game objects travel along the visible staff lines until colliding with the virtual musical instrument at the corresponding virtual key.

Reference throughout this specification to features, advantages, or similar language does not imply that all of the features and advantages that may be realized with the present invention should be or are in any single embodiment of the invention. Rather, language referring to the features and advantages is understood to mean that a specific feature, advantage, or characteristic described in connection with an embodiment is included in at least one embodiment of the present invention. Thus, discussion of the features and advantages, and similar language, throughout this specification may, but do not necessarily, refer to the same embodiment.

Furthermore, the described features, advantages, and characteristics of the invention may be combined in any suitable manner in one or more embodiments. One skilled in the relevant art will recognize that the invention can be practiced without one or more of the specific features or advantages of a particular embodiment. In other instances, additional features and advantages may be recognized in certain embodiments that may not be present in all embodiments of the invention.

These features and advantages of the present invention will become more fully apparent from the following description and appended claims, or may be learned by the practice of the invention as set forth hereinafter.

### BRIEF DESCRIPTION OF THE DRAWINGS

In order for the advantages of the invention to be readily understood, a more particular description of the invention briefly described above will be rendered by reference to specific embodiments that are illustrated in the appended drawing(s). Understanding that these drawing(s) depict only typical embodiments of the invention and are not therefore to be considered to be limiting of its scope, the invention will be described and explained with additional specificity and detail through the use of the accompanying drawing(s), in which:

FIG. 1 is a module diagram of the system for network communication of music data, according to one embodiment of the invention;

FIG. 2 is a module diagram of the system for network communication of music data, according to one embodiment of the invention;

FIG. 3 is a module diagram of the system for network communication of music data, according to one embodiment of the invention;

FIG. 4 illustrates a graphical user interface according to one embodiment of the invention;

FIG. 5 illustrates a graphical user interface showing visual feedback, according to one embodiment of the invention;

FIG. 6 illustrates a method of network communication of music data, according to one embodiment of the invention;

FIG. 7 illustrates a method of network communication of music data, according to one embodiment of the invention; and

FIG. 8 illustrates a method of network communication of music data, according to one embodiment of the invention.

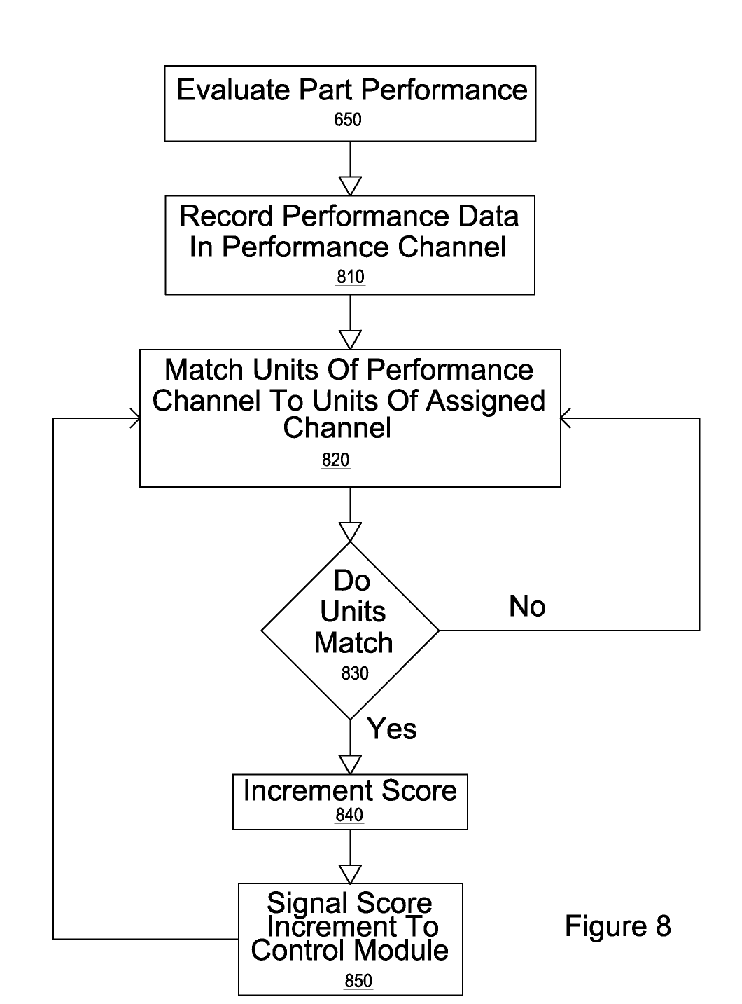

### DETAILED DESCRIPTION OF THE INVENTION

For the purposes of promoting an understanding of the principles of the invention, reference will now be made to the exemplary embodiments illustrated in the drawing(s), and specific language will be used to describe the same. It will nevertheless be understood that no limitation of the scope of the invention is thereby intended. Any alterations and further modifications of the inventive features illustrated herein, and any additional applications of the principles of the invention as illustrated herein, which would occur to one skilled in the relevant art and having possession of this disclosure, are to be considered within the scope of the invention.

Reference throughout this specification to “one embodiment,” “an embodiment,” or similar language means that a particular feature, structure, or characteristic described in connection with the embodiment is included in at least one embodiment of the present invention. Thus, appearances of the phrases “one embodiment,” “an embodiment,” and similar language throughout this specification may, but do not necessarily, all refer to the same embodiment, different embodiments, or component parts of the same or different illustrated invention. Additionally, reference to the wording “an embodiment,” or the like, for two or more features, elements, etc. does not mean that the features are related, dissimilar, the same, etc. The use of the term “an embodiment,” or similar wording, is merely a convenient phrase to indicate optional features, which may or may not be part of the invention as claimed.

Each statement of an embodiment is to be considered independent of any other statement of an embodiment despite any use of similar or identical language characterizing each embodiment. Therefore, where one embodiment is identified as “another embodiment,” the identified embodiment is independent of any other embodiments characterized by the language “another embodiment.” The independent embodiments are considered to be able to be combined in whole or in part one with another as the claims and/or art may direct, either directly or indirectly, implicitly or explicitly.

Finally, the fact that the wording “an embodiment,” or the like, does not appear at the beginning of every sentence in the specification, such as is the practice of some practitioners, is merely a convenience for the reader's clarity. However, it is the intention of this application to incorporate by reference the phrasing “an embodiment,” and the like, at the beginning of every sentence herein where logically possible and appropriate.

As used herein, “comprising,” “including,” “containing,” “is, are,” “characterized by,” and grammatical equivalents thereof are inclusive or open-ended terms that do not exclude additional unrecited elements or method steps. “Comprising” is to be interpreted as including the more restrictive terms “consisting of” and “consisting essentially of.”

Many of the functional units described in this specification have been labeled as modules, in order to more particularly emphasize their implementation independence. For example, a module may be implemented as a hardware circuit comprising custom VLSI circuits or gate arrays, off-the-shelf semiconductors such as logic chips, transistors, or other discrete components. A module may also be implemented in programmable hardware devices such as field programmable gate arrays, programmable array logic, programmable logic devices or the like.

Modules may also be implemented in software for execution by various types of processors. An identified module of programmable or executable code may, for instance, comprise one or more physical or logical blocks of computer instructions which may, for instance, be organized as an object, procedure, or function. Nevertheless, the executables of an identified module need not be physically located together, but may comprise disparate instructions stored in different locations which, when joined logically together, comprise the module and achieve the stated purpose for the module.

Indeed, a module and/or a program of executable code may be a single instruction, or many instructions, and may even be distributed over several different code segments, among different programs, and across several memory devices. Similarly, operational data may be identified and illustrated herein within modules, and may be embodied in any suitable form and organized within any suitable type of data structure. The operational data may be collected as a single data set, or may be distributed over different locations including over different storage devices, and may exist, at least partially, merely as electronic signals on a system or network.

The various system components and/or modules discussed herein may include one or more of the following: a host server or other computing systems including a processor for processing digital data; a memory coupled to said processor for storing digital data; an input digitizer coupled to the processor for inputting digital data; an application program stored in said memory and accessible by said processor for directing processing of digital data by said processor; a display device coupled to the processor and memory for displaying information derived from digital data processed by said processor; and a plurality of databases. Various databases used herein may include: show data, participant data; sponsor data; financial institution data; and/or like data useful in the operation of the present invention. As those skilled in the art will appreciate, any computers discussed herein may include an operating system (e.g., Windows NT, 95/98/2000, OS2, UNIX, Linux, Solaris, MacOS, etc.) as well as various conventional support software and drivers typically associated with computers. The computers may be in a home or business environment with access to a network. In an exemplary embodiment, access is through the Internet through a commercially-available web-browser software package.

As set forth in the specification, the system and method of the invention may facilitate the providing information to participants through multiple media sources and may allow the player modules to receive information via similar multiple media sources. The multiple media sources may include, for example, chat room, radio, bulletin board, internet web pages, email, billboards, newsletters, commercials and/or the like. The present invention may be described herein in terms of functional block components, screen shots, optional selections and various processing steps. It should be appreciated that such functional blocks may be realized by any number of hardware and/or software components configured to perform the specified functions. For example, the present invention may employ various integrated circuit components, e.g., memory elements, processing elements, logic elements, look-up tables, and the like, which may carry out a variety of functions under the control of one or more microprocessors or other control devices. Similarly, the software elements of the present invention may be implemented with any programming or scripting language such as C, C++, Java, COBOL, assembler, PERL, Visual Basic, SQL Stored Procedures, extensible markup language (XML), with the various algorithms being implemented with any combination of data structures, objects, processes, routines or other programming elements. Further, it should be noted that the present invention may employ any number of conventional techniques for data transmission, signaling, data processing, network control, and the like. Still further, the invention may be used to detect or prevent security issues with a client-side scripting language, such as JavaScript, VBScript or the like. For a basic introduction of cryptography and network security, the following may be helpful references: (1) “Applied Cryptography: Protocols, Algorithms, And Source Code In C,” by Bruce Schneier, published by John Wiley & Sons (second edition, 1996); (2) “Java Cryptography” by Jonathan Knudson, published by O'Reilly & Associates (1998); (3) “Cryptography & Network Security: Principles & Practice” by William Stalling, published by Prentice Hall; all of which are hereby incorporated by reference.

Additionally, many of the functional units and/or modules herein are described as being “in communication” with other functional units and/or modules. Being “in communication” refers to any manner and/or way in which functional units and/or modules, such as, but not limited to, computers, laptop computers, PDAs, modules, and other types of hardware and/or software, may be in communication with each other. Some non-limiting examples include communicating, sending, and/or receiving data and metadata via: a network, a wireless network, software, instructions, circuitry, phone lines, internet lines, satellite signals, electric signals, electrical and magnetic fields and/or pulses, and/or so forth.

As used herein, the term “network” may include any electronic communications means which incorporates both hardware and software components of such. Communication among the parties in accordance with the present invention may be accomplished through any suitable communication channels, such as, for example, a telephone network, an extranet, an intranet, Internet, point of interaction device (point of sale device, personal digital assistant, cellular phone, kiosk, etc.), online communications, off-line communications, wireless communications, transponder communications, local area network (LAN), wide area network (WAN), networked or linked devices and/or the like. Moreover, although the invention may be implemented with TCP/IP communications protocols, the invention may also be implemented using IPX, Appletalk, IP-6, NetBIOS, OSI or any number of existing or future protocols. If the network is in the nature of a public network, such as the Internet, it may be advantageous to presume the network to be insecure and open to eavesdroppers. Specific information related to the protocols, standards, and application software utilized in connection with the Internet is generally known to those skilled in the art and, as such, need not be detailed herein. See, for example, DILIP NAIK, INTERNET STANDARDS AND PROTOCOLS (1998); JAVA 2 COMPLETE, various authors, (Sybex 1999); DEBORAH RAY AND ERIC RAY, MASTERING HTML 4.0 (1997); and LOSHIN, TCP/IP CLEARLY EXPLAINED (1997), the contents of which are hereby incorporated by reference.

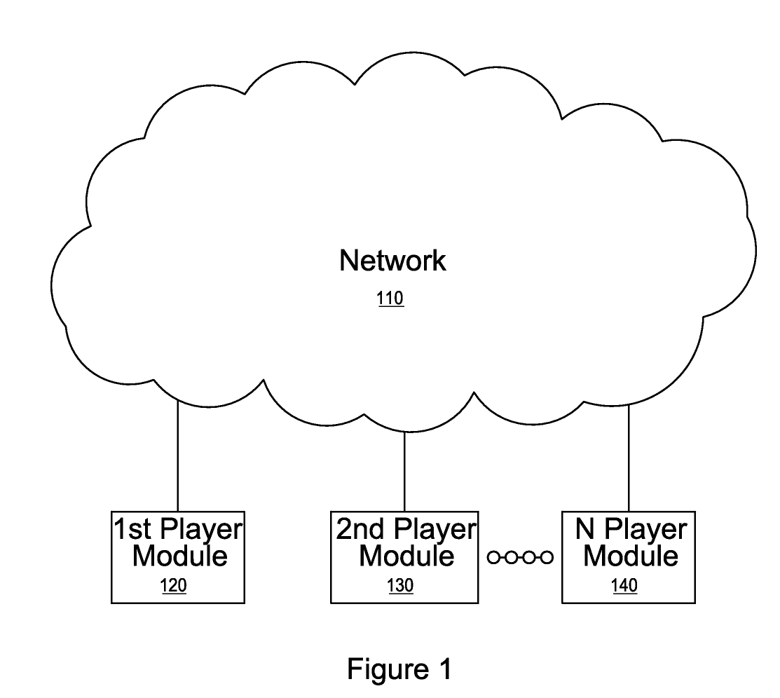

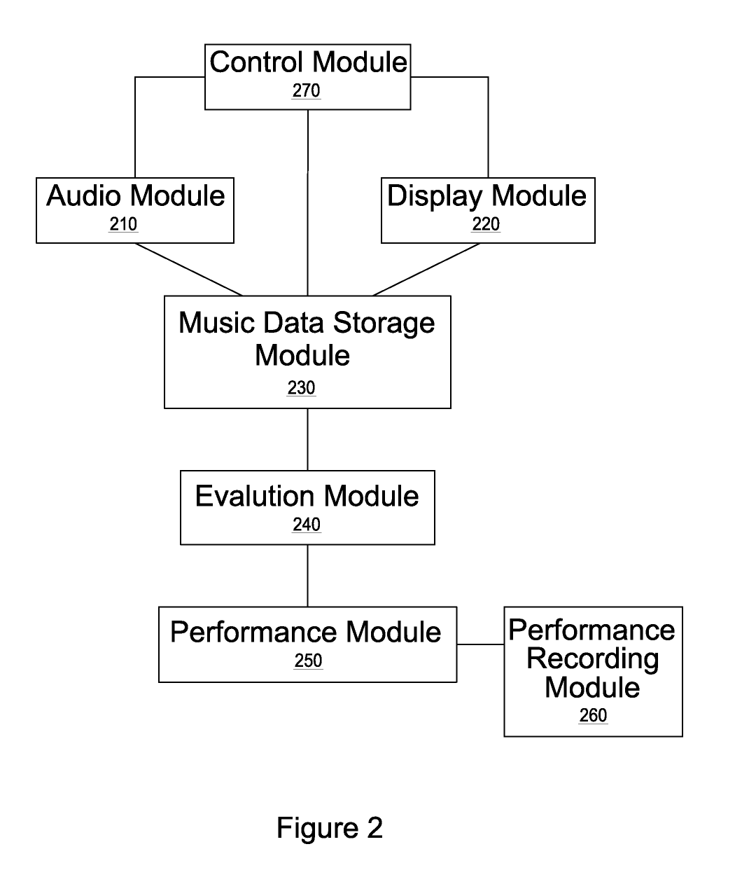

As shown in the FIGS. 1 and 2, there is a system 100 for communicating music data over network comprising: a network module 110; a control module 270 in communication with the network module 110; a music data storage module 230 in communication with the control module 270, and configured to store music data, the music data storage module including: an assigned channel and a unassigned channel. They system 100 also includes a first player module 120 in communication with the network module 110, including: an audio module 210 in communication with the music data storage module 230, and configured to broadcast audio; a display module 220 in communication with the music data storage module 230, and configured to visually display data; an evaluation module 240 in communication with the display module 220, and configured to evaluate a performance; and a performance module 250, in communication with the evaluation module 240, and configured to convert a music performance to music performance data. The system 100 additionally includes a second player module 130 in communication with the network module 110. Indeed, the system 100 may include a plurality of player modules 140 in communication with the network module 110.

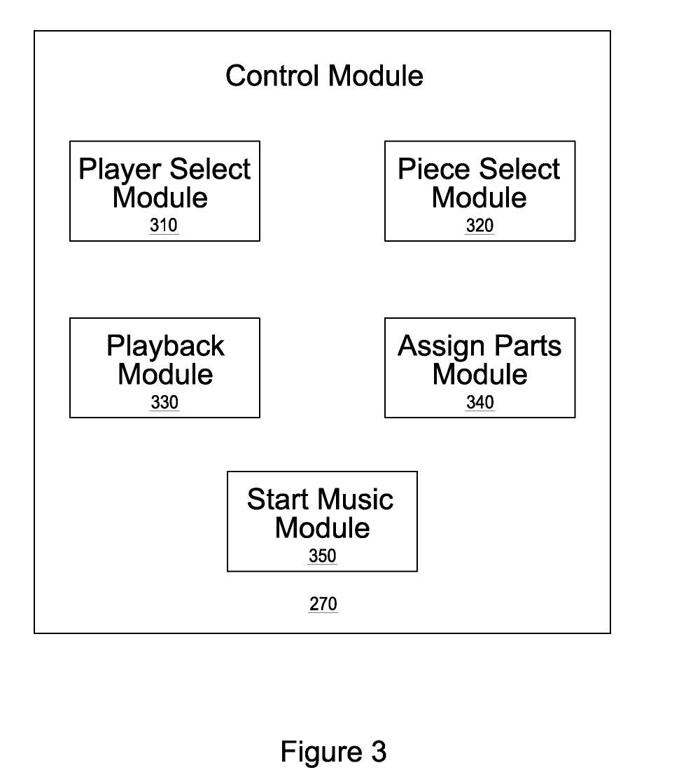

As shown in FIGS. 2 and 3, the system 100 for communicating data over a network includes a control module 270 in communication with the network module 110. The control module 270 may include: operating software, instructions and/or hardware, which would enable the control module 270 to perform a variety of functions. The control module 270 additionally includes a player select module 310. The player select module 310 may function to enable the first player module 120, the second player module 130, and/or indeed, the plurality of player modules 140 to select from one more other player modules 140 that are, or may be in communication with the network module 110. The player select module 310 may include a list of those player modules. The list of player modules may include: player module name or ID, the type and/or kind of performance module 250 associated with the player module, any personal preferences, attributes, information, and/or any other information contemplated in the art.

In an another embodiment, the player select module 310 may additionally, include a player grouping module which may function to allow various groups of player modules to form based on various attributes, types, personal information, and/or so forth. The player grouping module may include instruction for enabling groups to become private, requiring an ID and/or password to become a group member. Alternatively, the player grouping module may include instructions for enabling a public group, wherein any player module may participate and/or become connected. The player select module 310 may be operated by or include anything contemplated in the art, such as but not limited to software, hardware, operating systems, and/or so forth. In one non-limiting example, the player select module 310 includes multiplayer game hosting software like those available from DemonWare located at 69 Middle Abbey St., Dublin, Ireland or at www.demonware.net.

Also shown in FIG. 3, the control module 270 includes a piece select module 320. The piece select module 320 may include instructions, hardware, and/or software that would enable one or more player modules 140 to select one or more music pieces. The piece select module may be or be incorporated as part of a music playing software and MIDI, such as available from Harmony Central, located at www.harmony-central.com.

As shown in FIG. 3, the control module 270 additionally includes a playback module 330 configured to playback music data. The playback module 330 may include instructions for playing music data in a variety of speeds, sounds, lengths, and/or so forth. Additionally, the playback module 330 may enable one or more player modules 140 to control the manner in which music data is played. The playback module 330 may be incorporated and/or take any form contemplated in the art, such as but not limited to software, hardware, operating systems, and/or so forth. In one non-limiting example, the playback module 330 includes music playing software, such as MIDI or other known music playing software, like those available from Harmony Central located at www.harmony-central.com.

Additionally, FIG. 3 shows the control module 270 includes an assign parts module 340, configured to assign parts of a musical piece to one or more player modules 140. The assign parts module 340 may include instructions or be incorporated into a variety of multiplayer game hosting software and/or operating systems as described herein. In one non-limiting example, the assign parts module 340 assigns a variety of the musical parts from a musical piece selected from the piece select module 320 such as, but not limited to, guitar, drum, bass, violin and so forth, to one or more player modules 140 associated with the player select module 310. Certain MIDI files and other music data files are already broken up into parts and/or tracks or the equivalent of voice and/or orchestral parts. The assign parts module 340 may include instructions and/or be incorporated into a variety of music play systems, MIDIs, and/or operating systems as described herein.

Also shown in FIG. 3, the control module includes a start music module 350 configured to begin function to play the musical piece select by the piece select module 320. The start music module may include instructions and/or be incorporated into a variety of music play systems, MIDIs, and/or operating systems as described herein.

As illustrated in the figures the system 100 includes a music data storage module 230 in communication with the control module 270, and configured to store music data. The music data storage module 230 may include any hardware, software, or other data storage medium contemplated in the art. Some non-limiting examples include: cartridges, hard drives, flash memory, USB memory sticks, and/or so forth.

Also shown in the figures, the music data storage module 230 includes: an assigned channel or track and an unassigned channel or track. A channel may include a subset of a larger set of data. The assigned channel may comprise data associated with the assigned music part, assigned by the assign parts module 340, as previously described. Additionally, the assigned channel may be configured to and includes instructions for receiving and/or storing music data associated with one or more player modules' 140 assigned part of a music composition. In one non-limiting example, the assigned parts module 340 assigns a first player module 120 to the guitar part of a music composition. The assigned channel comprises the guitar part of the music composition assigned to the first player module 120. In this example, the guitar part may comprise a series and/or plurality of notes to be played in a rhythmic pattern. The assigned channel may be embodied in the series of notes to be played. In another non-limiting example, the assigned channel may be displayed on the display module 220. In another non-limiting example, the assigned channel includes a series of notes to be played in a rhythmic pattern. The series of notes 430 may additionally be visually display on the display module 220.

Also shown in the figures, the music data storage module 230 includes an unassigned channel. The unassigned channel may comprise prerecorded and/or predetermined music data. Predetermined music and/or prerecorded music data may include a song and/or orchestral piece as performed by the original artist or as sung or played by professional musician, or as described herein. Additionally, the unassigned channel may be configured to and include instructions for receiving and/or storing all the music data not associated with a player module's assigned part of a musical composition. In one non-limiting example, the unassigned music channel includes music data in form of mp3, MIDI format, and/or other form that is not assigned and/or associated with an assigned part of one or more player modules 140.

Additionally, as shown in the figures, the system 100 includes a first player module 120, a second player module 130, and/or a plurality of player modules 140 in communication with a network module 110. The first player module 120 includes: an audio module 210 in communication with the music data storage module 230, and configured to broadcast audio; a display module 220 in communication with the music storage module, and configured to visually display data; an evaluation module 240 in communication with the display module 220, and configured to evaluate a performance; and a performance module 250 in communication with the evaluation module 240, and configured to convert a music performance to music performance data. The first player module 120, second player module 130, and/or plurality of player modules 140 may include any components, software, hardware, and/or features associated with a user connecting to or communicating data over a network. Some non-limiting examples include: a computer, a software package, any type and/or kind of MIDI instrument, and/or so forth. Indeed, the first player module 120, a second player 130, and/or a plurality of player modules 140 may comprise a user and/or persons who are using the computer and/or software components.

As shown in the figures, the system 100 includes an audio module 210 in communication with the music data storage module 230, and configured broadcast audio. The audio module 210 may be incorporated as part of one or more of the player modules 140, be its own system and/or component, and/or be incorporated as part of a centralized system or server. The audio module 210 may be any component, software, hardware, etc. contemplated in the art which functions and/or assists in broadcasting audio, such as, but not limited to music data and/or music files. Some non-limiting examples include: audio cords, audio speakers, audio software, and/or so forth. Such systems and/or components are readily available and easily accessible those skilled in the art.

In one embodiment, the system 100 includes a first mode, wherein the audio module 210 plays music data from and/or associated with unassigned channel and does not play music data from and/or associated with the assigned channel. In one non-limiting example, a plurality of player modules 140 are connected via a network module 110, each with one more assigned parts of a musical piece and/or composition. The audio module 210 audibly plays to first player module 120 music data from the unassigned channel or predetermined music data, but does not play music data from the assigned channel. As demonstrated by the first mode, a first player module 120 may play or perform his or her assigned part while hearing predetermined music data from the unassigned channel. By not playing the assigned channels the interference and/or potential imperfections in the assigned parts of other player modules may not negatively affect the first player module 120.

In another embodiment, the system 100 includes a performance recording module 260. The performance recording module 260 includes instructions for recording performance data from one or more player modules 140. Additionally, the performance recording module may include instructions for executing a second mode, wherein the audio module 210 simultaneously plays a recorded performance from the first player module 120 and a performance from the second player module 130. The second mode may enable one or more player modules 140 to listen to his or her performance in combination with performances recordings associated with other player modules 140.

As shown in the figures, the system 100 additionally includes a display module 220 in communication with the music storage module 230, and configured to visually display data. The display module 220 includes instructions and/or components which function to display the assigned channel and/or other data as required. As discussed previously, the assigned channel is that data associated with an assigned part of a musical composition. Therefore, the display module 220 may function to display data associated with the assigned parts of one or more player modules 140.

Additionally, as shown in the figures, the display module 220 includes a graphical user interface 400. The graphical user interface 400 further includes a virtual musical instrument 410 positioned substantially at the top portion of the graphical user interface 400. In being positioned substantially at the top portion of the graphical user interface 400, the virtual musical instrument 410 may be aligned and with the top edge of the graphical user interface 400 or may be positioned away from the top edge of the graphical user interface 400 such that data and/or other graphics may be place above the top of the virtual music instrument 410. The graphical user interface 400 may be embodied and/or incorporate as part of any graphical user interface module contemplated in the art. In one non-limiting example, the graphical user interface module includes a display screen on a computer monitor.

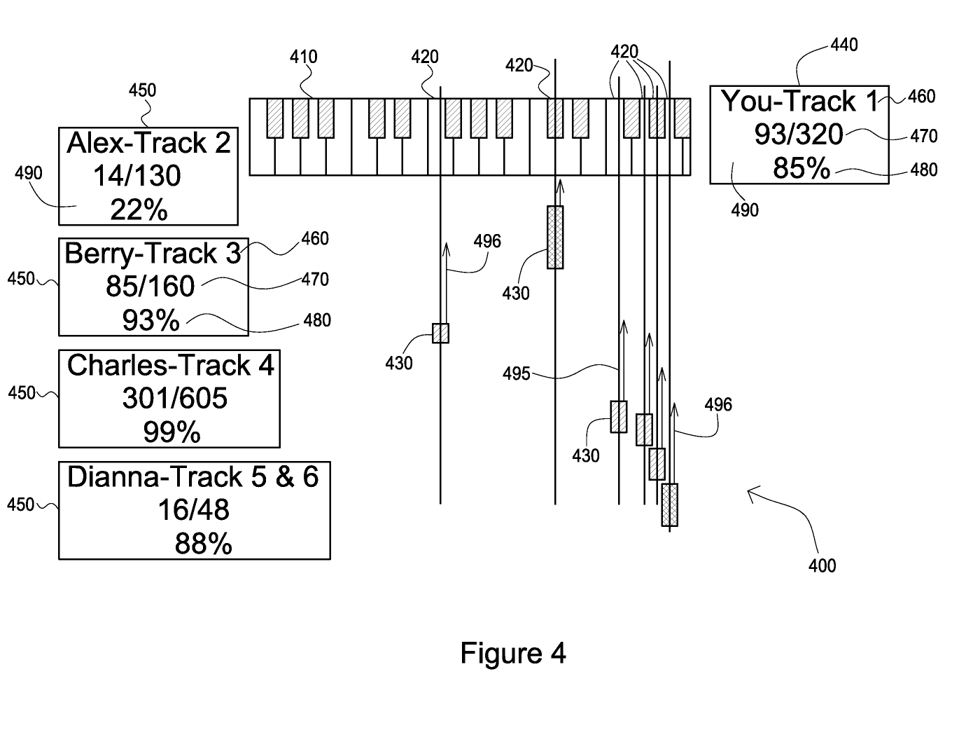

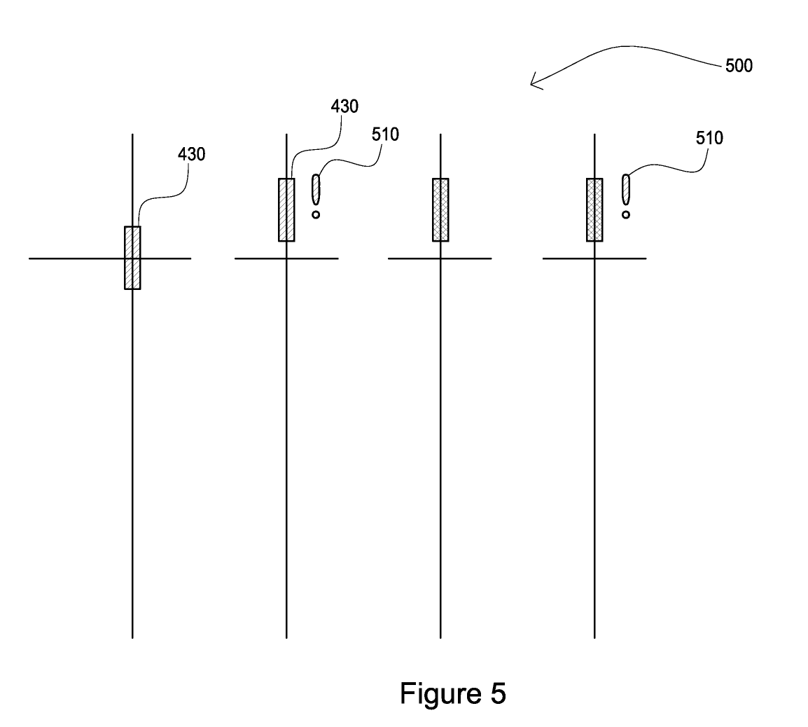

Further, as shown in FIGS. 4 and 5, the virtual music instrument includes a plurality of virtual keys 420, each key corresponding to a key on the performance module 250. The virtual music instrument 410 may be any virtual music instrument contemplated in the art. Some non-limiting examples include: a guitar, a piano and/or piano keyboard, a drum and/or drum set, a saxophone, a violin, and/or so forth. The plurality of keys 420 may be disposed and/or oriented in any manner contemplated in the art.

Also shown in FIGS. 4 and 5, the display module further comprises a game object 430. The game object 430 includes a plurality of musical notes 430 in sequence having a rhythmic pattern associated with musical performance data. In one non-limiting example, the display module 220 further includes instructions and/or components which enable the game object 430 to be directed upward on the graphical user interface 400 in a substantially straight trajectory 496 toward the plurality of keys 420. In being substantially straight, the trajectory 496 may or may not be a straight upward direction, but may veer slightly to the right and/or left. Additionally, the trajectory 496 of the game object 430 may include patterns and/or designed trajectories comprising a variety of angles and/or trajectories configured to challenge and/or entertain one or more player modules 140.

Additionally, as shown in FIGS. 4 and 5, the graphical interface 400 includes a series of visible staff lines 495, wherein the visible staff lines 495 correspond to the substantially straight trajectories 496 of the game objects 430; such that the game objects 430 travel along the visible staff lines 495 until the game object 430 collides with the corresponding virtual key 420. In one non-limiting example, the game object 430 travels upward along a visible staff line 495 toward the virtual key 420 until the game object 430 collides with the corresponding virtual key 420. In another non-limiting example, the game object 430 comprises a musical note which corresponds to a musical note to be played for a musical performance, on the performance module 250, and/or associated with one or more player modules 140.

As shown in FIGS. 4 and 5, the system 100 includes instructions for awarding a value 510 to one or more player modules 140 based upon the one more player modules 140 striking the corresponding key on the musical performance module 250 approximately simultaneously as the game object 430 collides with the virtual keys 420. In being “approximately simultaneous”, one or more player modules 140 or users may or may not strike a corresponding key on his or her performance module 250 at the exact moment a game object 430 collides with a virtual key 420. An award value 510 may be awarded to one or more player modules 140 if the player modules' 140 strike a corresponding key on his or her performance module 250 one or two seconds before and/or after the exact moment a game object 430 collides with a virtual key 420.

In one embodiment, the meaning of “approximately simultaneous” may be changed and/or set by one or more player modules 140. The graphical user interface module may include instructions for including varying degrees of difficulty which may or may not be changed by one or more player modules 140. In one non-limiting example, a degree of difficulty may include expert; wherein “approximately simultaneous” means the exact moment a game object 430 collides with a virtual key 420. In another non-limiting example, a degree of difficulty may include beginner; wherein “approximately simultaneous” means two seconds before and/or after a game object 430 collides with a virtual key 420.

In another embodiment, one or more player modules' musical performance module 250 comprises a piano keyboard and the game object 430 and virtual key 420 corresponds to the note “C” or “C” key. As the game object 430 or musical note collides with the corresponding virtual key 420, the player modules 140 are awarded a value 510 if he or she strikes the corresponding “C” key on his or her musical performance module or piano keyboard. The award value 510 may be any award value contemplated in the art. Some non limiting examples of award values include: points, a percentage, an increment in one more player module's score, a graphical icon appearing on a player module graphical user interface, such as, but not limited to: a star, an exclamation point, and/or so forth.

As shown in FIG. 2, the system 100 additionally includes an evaluation module 240 in communication with the display module 220, and configured to evaluate a performance. The evaluation module 240 functions and/or may include instructions for evaluating a musical performance of one or more player modules 140. Evaluating the musical performance may include: recording performance in the performance channel 810; matching units of the performance channel to units of the assigned channel 820; incrementing one or more player modules' score if a positive match is determined 840, and signaling the score increment to the control module 850. In one embodiment, the performance channel includes performance data associated with the musical performance module 250, or the musical performance data associated with the musical performance of one or more player modules 140.

As shown in FIGS. 4 and 5, the evaluation module 240 functions to execute a third mode, wherein the display module 220 displays evaluation data 490 associated with the first player module 120. In an additional embodiment, the display module 220 may simultaneously, display evaluation data 490 associated with the first player module 120 and evaluation data 490 associated with the second player module 130 during the first mode. Indeed, the display module 220 may display a plurality of evaluation data 490 associated with a one more player modules 140. The evaluation data 490 may be displayed in any manner or form contemplated in the art. In one non-limiting example, the evaluation data 490 comprises one or more icons visually disposed on the graphical user interface 400. Additionally, the evaluation data 490 may be any type and/or kind of evaluation data contemplated in the art. Some non-limiting examples of the evaluation data 490 include: data associated with one or more player modules 460 or users, data associated with a track and/or assigned channels of one or more player modules 460, data associated with one more player modules' 140 scores or awarded values 470 and/or percentages 480, and/or so forth.

In an additional embodiment, displaying evaluation data includes one or more displayed icons 440 wherein one more player modules 140 may select to see more data associated with a particular player module 120. Selecting to see more data may be accomplished by clicking on a player module's icon 440 and/or scrolling a mouse or other computer pointer over a particular plays module's icon 440.

As shown in FIG. 2, the system 100 includes a performance module 250 or musical performance module 250 in communication with the evaluation module 240, and configured to convert a musical performance to musical performance data. The performance module 250 functions and/or includes instructions for converting a musical performance to musical performance data. The performance module 250 may comprise include any type and/or kind of transducer contemplated in the art which functions to convert a musical performance to musical performance data. In one non-limiting example, the transducer includes a transducer for a stringed instrument or a wind instrument, such as those taught in U.S. Pat. Nos. 6,271,456 and 4,527,456 which are incorporated herein by reference. Additionally, a variety of types and/or kinds of transducers, including Piezo transducers, may be available at www.amazon.com.

In another embodiment, the performance module 250 includes a variety of musical instruments with which one or more player modules 140 may perform. Some non-limiting examples of musical instruments include: a piano, a piano keyboard, a guitar, drums, a violin, and/or so forth. The performance module 250 or musical instrument 250 may or may not include one or more transducers as described above. Additionally, the performance module 250 or the musical instrument 250 may or may not include a variety of ports and/or hookups, such as but not limited USB, or communication ports, enabling the musical instrument to be either be in direct or indirect communication with the evaluation module 240, the control module 270, and/or other modules.

In yet another embodiment, there is a method and a computer readable storage medium comprising computer readable program code configured to execute on a processor for communicating musical data over a network, the program code configured to and/or execute a method for: connecting a first player module 120 to a network 110; providing an unassigned channel of prerecorded music data; providing an assigned channel of prerecorded music data; displaying the assigned channel; playing the unassigned channel while not playing the assigned channel; converting musical performance to music performance data; evaluating the music performance data in regard to the assigned channel; and delivering a representation of the evaluation over the network. The program code may additionally be configured to and/or execute a method for connecting two more or player modules 140 to a network 110. The network may comprise any type and/or kind of network contemplated in the art, or as described herein. In one non-limiting example, the network 110 comprises a plurality of player modules 140 interconnected via a network.

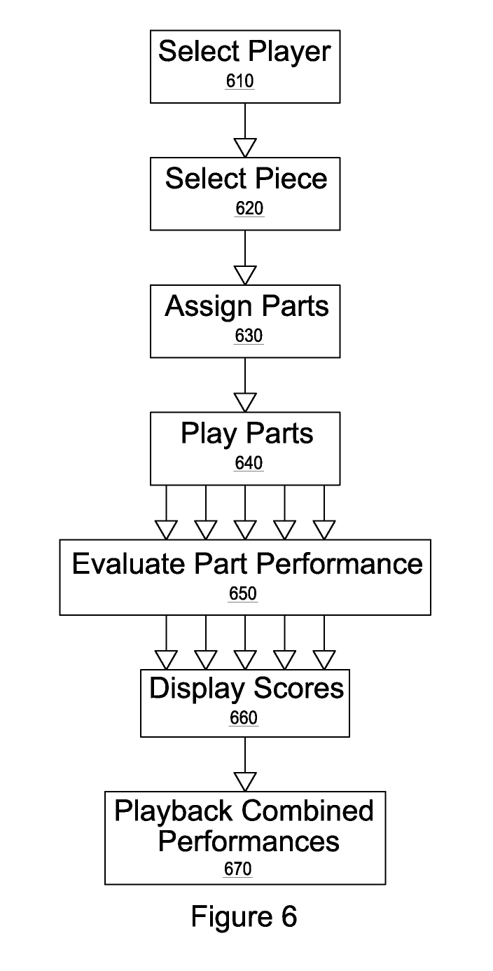

As demonstrated by FIG. 6, the program code may be configured to and/or execute a method for selecting one or more player modules 610. Selecting one or more player modules 610 may be executed by and/or include anything contemplated in the art, or as described herein. In one non-limiting example, the selection of one or more player modules 140 may be embodied in a list of available and/or connected player modules from which one or more player modules 140 may select. The list may include any data contemplated in the art. Some non-limiting examples of data include: location, associated performance module, connection speed, experience level, and/or so forth.

Also shown in FIG. 6, the program code may be configured to and/or execute a method for selecting a piece of music and/or music composition 620 to be played by one or more player modules 140. Selecting the piece of music 620 may be executed by and/or include anything contemplated in the art, or as described herein. In one non-limiting example, the selection of the piece of music 620 may be embodied in a list of available and/or stored musical compositions from which one or more player modules 140 may select. The list of musical compositions may include any data contemplated in the art. Some non-limiting examples of data include: type, artist, composer, genre, size, length, skill level, and/or forth. Additionally, the musical composition may include any type of musical composition contemplated in the art. Some non-limiting examples of music compositions include: choral, orchestral, jazz band, rock, solos, duets, trios, and/or so forth.

Additionally, as shown in FIG. 6, the program code may be configured to and/or execute a method for assigning parts of a music composition 630. In assigning parts of a music composition 630, the program code may be configured to and/or execute a method for assigning one or more parts of a music composition to one more player modules 140. Assigning one or more parts of a music composition 630 to one more player modules 140 may be executed and/or include anything contemplated in the art or as described herein. In one non-limiting examples, one or more player modules 140 may select which parts to be assigned or may select to have a part randomly assigned. Indeed, there may be instructions for providing a list of parts accompanied by data associated with each part.

In one embodiment, assigning parts music composition 630 may include providing an unassigned channel of prerecorded music data. The prerecorded music data may be any music data contemplated in the art, or as described herein. In one non-limiting example, prerecorded music data comprises music data performed by and/or recorded by professional artists. In another non-limiting example, the music data performed professional artist comprises a Beethoven symphony performed by a professional symphony orchestra.

In another embodiment, assigning parts of music composition 630 includes providing an assigned channel of prerecorded music data. Providing an assigned channel of prerecorded music data may be executed and/or include anything contemplated in the art or as described herein. The assigned channel includes music data, as described previously, associated with the assigned part of a musical composition; each part being assigned to one or more player modules 140. The assigned channel may be displayed or communicated to one or more player module in any way contemplated in the art, or as described herein.

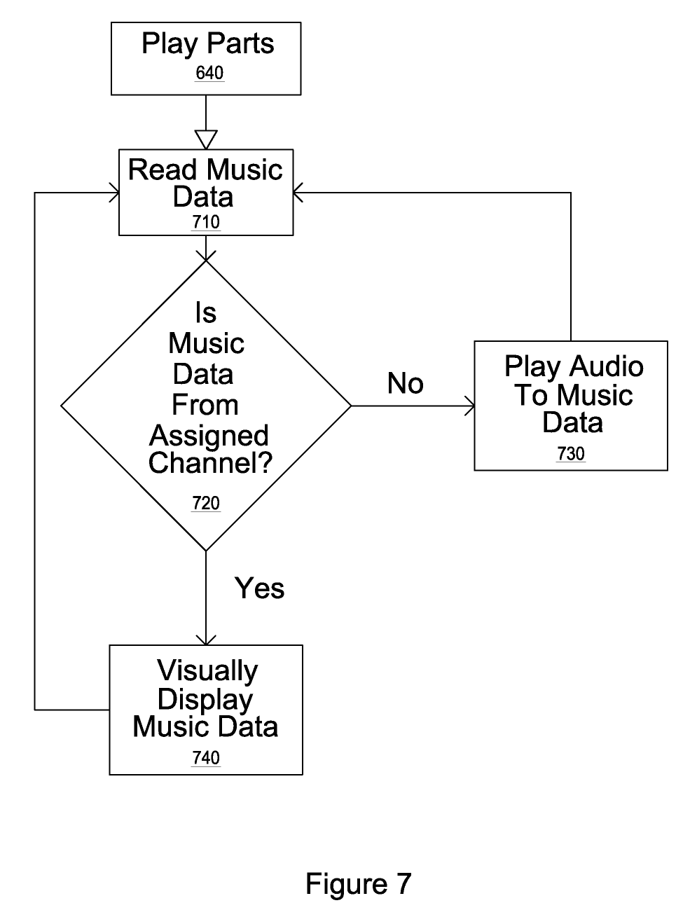

Additionally, as shown in FIGS. 6 and 7, the program code is configured to and/or executes a method for playing parts of a music composition 640. Playing parts of a music composition 640 includes: reading music data 710; determining if the music data is from an assigned channel 720; if the music data is not from an assigned channel, then audibly playing the music data 730; and if the music data is from an assigned channel, then visually displaying the music data 740.

In one embodiment, reading the music data 710 and determining if the music data is from an assigned channel 720 may include components and/or be executed in any form contemplated in the art, or as described herein. In one non-limiting example, reading music data may be a function of the control module and/or evaluation module as herein described.

Also, as shown in FIG. 7, playing parts of a music composition 640 includes determining if the music data is from an assigned channel 720. As described previously, an assigned channel comprises music data associated with an assigned part of a music composition which may be assigned to one or more player modules 140.

As shown in FIG. 7, a negative, or no result from the determination of music data from an assigned channel 720 includes audibly playing the music data and/or assigned channel 730. Audibly playing the music data or the assigned channel 730 may include components and/or be executed in any form contemplated in the art, or as described herein. In one non-limiting example, audibly playing music data 730 may be a function of the audio module as herein described.

Also, shown in FIG. 7, a positive, or yes result from the determination of music data from an assigned channel 720, includes visually displaying the music data and/or assigned channel 740. Visually displaying the music data or the assigned channel 740 may include components and/or be executed in any form contemplated in the art, or as described herein. In one non-limiting example, visually displaying music data 740 may be a function of the display module as herein described.

In one embodiment, the program code is configured to and/or executes a method for displaying the assigned channel, as previously described, while playing an unassigned channel. The unassigned channel may include and/or be embodied in any form contemplated in the art or as herein described. Playing data from an unassigned channel may include any form of playing contemplated in the art, or as herein described. Some non-limiting examples of playing the unassigned channel include: audibly playing, playing video data, and/or so forth.

As shown in FIGS. 6 and 7, the program code may be configured to and/or execute a method for evaluating a part performance 650 or music performance data regarding an assigned channel. Evaluating a part performance 650 includes: recording performance data in a performance channel 810; matching units of the performance channel to units of an assigned channel 820; if a positive result is obtained, then incrementing a score 840, and signaling the score increment to the control module 850; if a negative result is obtained, then subsequent matching units of performance to units of assigned channels occurs 820. Evaluating a part performance may include components and/or be executed in any form contemplated in the art, or as described herein. In one non-limiting example, evaluating performance data may be a combination of the functions of the performance recording module 260, the control module 270, and/or the evaluation module 240, as herein described.

As shown in FIG. 6, the program code is configured to and/or executes the method for displaying one more scores associated with one or more player modules 660. Displaying scores 660 may include components and/or be executed in any form contemplated in the art, or as described herein. In one non-limiting example, the evaluation module 240 communicates and/or signals score increments to the display module 220, as described herein.

In an additional embodiment, evaluation data and/or representations of the evaluation data associated with a player modules' performance are communicated over a network to one more player modules. Indeed, the representations of the evaluation data may be embodied or take any form as contemplated in the art, or as described herein. In one non-limiting example, the evaluation module 240 and/or the control module 270 function to communicate one or more sets of evaluation data.

Also, as shown in FIG. 6, the program code is configured to and/or executes a method for playing back combined performances 670. Playback of the combined performance may include components and/or be executed in any form contemplated in the art, or as described herein. In one non-limiting example, the performance data associated with one more player modules is recorded 810. One or more player modules may be able to playback, view, and/or listen to the combined playback of one or more sets of performance data 670. The playback of the combined performance data 670 may be simultaneous, staggered, and/or so forth. The audio module 210, performance recording module 260, and/or the control module 270 may function to playback one or more combined performances, as described herein.

In an alternative embodiment, the performance data may be played back in an audible and/or visual form. The visual form allows one or more player modules 140 to view data associated with one or more player modules. Additionally, performance data may be played back and/or modified in any manner contemplated in the art, or as herein described.

In still another embodiment, the program code is configured to and/or executes a method for converting a musical performance to music performance data. The musical performance and music performance data may be embodied and/or may include any musical performance and music performance data as contemplated in the art, or as herein described. Additionally, the conversion of a musical performance to music performance may be enabled in any manner contemplated in the art, or as herein described.

In another embodiment, the program code is further configured to and/or executes a method for generating: a graphical user interface, including a virtual instrument positioned substantially at a top portion of the graphical interface, wherein the virtual musical instrument includes a plurality of virtual keys, each key corresponding to a key on the performance module; incorporating a music file into the graphical user interface, wherein the music file contains data corresponding to an arrangement of a plurality of musical notes in sequence, having a rhythmic pattern, each note being represented by a game object; directing the game objects upward, in substantially straight trajectories, toward the virtual keys on the virtual musical instrument corresponding to the musical notes; colliding the game objects with the corresponding keys according to the rhythmic pattern of the arrangement; and awarding a value to the first player module based upon the first player module striking a corresponding key on the musical performance module approximately simultaneously with the collisions. The above described process and method may include components, modules, and/or be executed in any form contemplated in the art, or as described herein.

In a further embodiment, the program code is further configured to and/or executes a method for introducing a series of visible staff lines defining spaces, where the lines and spaces correspond to the substantially straight trajectories along which the game objects travel toward the virtual musical instrument, such that the game objects travel along the visible staff lines until colliding with the virtual musical instrument at the corresponding virtual key. The above described process and method may include components, modules, and/or be executed in any form contemplated in the art, or as described herein.

Advantageously, in one exemplary embodiment, one or more player modules 140 may communicate and/or connect their performance modules 250 or instruments to other player modules 140 over a network 110. Once one or more player modules 140 are connected, the second mode may enable player module 120 to see his or her assigned channel or part visually displayed on the graphical user interface 400 as shown in FIG. 4. A player module 120 may further be able to visually receive feedback as to how the other player modules 140 are scoring.

In another exemplary embodiment, the system and method 100 provide for limited or no negative interference from the data and/or performances associated with the other player modules 140. The first mode audibly plays unassigned channels, or prerecorded music data, and does not play the other player modules' 140 assigned channels. Thus, a player module 120 may play his or her assigned part along with prerecorded music.

For the sake of brevity, conventional data networking, application development and other functional aspects of the systems (and components of the individual operating components of the systems) may not be described in detail herein. Furthermore, the connecting lines shown in the various figures contained herein are intended to represent exemplary functional relationships and/or physical couplings between the various elements. It should be noted that many alternative or additional functional relationships or physical connections may be present in a practical electronic transaction system.

It is understood that the above-described embodiments are only illustrative of the application of the principles of the present invention. The present invention may be embodied in other specific forms without departing from its spirit or essential characteristics. The described embodiment is to be considered in all respects only as illustrative and not restrictive. The scope of the invention is, therefore, indicated by the appended claims rather than by the foregoing description. All changes which come within the meaning and range of equivalency of the claims are to be embraced within their scope.

Additionally, although FIG. 4 illustrates a piano keyboard, it is contemplated any musical instrument embodied in a virtual musical instrument. Some non-limiting examples of musical instruments include: a guitar, drums, a saxophone, wind instrument, and/or so forth.

Finally, it is envisioned that the components of the device may be constructed of a variety of materials, such as, but not limited to: software, hardware, circuitry, computer systems, network systems, electrical devices and/or components, musical instruments, and/or so forth.

Thus, while the present invention has been fully described above with particularity and detail in connection with what is presently deemed to be the most practical and preferred embodiment of the invention, it will be apparent to those of ordinary skill in the art that numerous modifications, including, but not limited to, variations in size, materials, shape, form, function and manner of operation, assembly and use may be made, without departing from the principles and concepts of the invention as set forth in the claims.

What is claimed is:

1. A system for communicating music data over a network, comprising:
a network module;
a control module in communication with the network module;
a music data storage module in communication with the control module, and configured to store music data, the music data storage module including:
an assigned channel; and
an unassigned channel;
a first player module in communication with the network module, including:
an audio module in communication with the music data storage module, and configured to broadcast audio, wherein the audio module in a first mode plays the unassigned channel and does not play the assigned channels;
a display module in communication with the music data storage module, and configured to visually display data, and wherein the display module displays the assigned channel;
an evaluation module in communication with the display module, and configured to evaluate a performance; and
a performance module, in communication with the evaluation module, and configured to convert a musical performance to musical performance data; and
a second player module in communication with the network module.

2. The system of claim 1, further comprising a second mode wherein the audio module plays simultaneously a recorded performance from the first player module and the second player module.

3. The system of claim 1, further comprising a third mode wherein the display module displays evaluation data associated with the first player module.

4. The system of claim 3, wherein the display module simultaneously displays evaluation data associated with the first player module and evaluation data associated with the second player module during the first mode.

5. The system of claim 1, wherein the display module further comprises:
a graphical user interface module, having a first position, including a virtual musical instrument positioned substantially at a top portion of the interface, the virtual musical instrument having a plurality of keys, each key corresponding to a key on the performance module;
a game object, wherein the game object includes a plurality of musical notes in sequence having a rhythmic pattern associated with musical performance data, and wherein the game object is directed upward on the graphical user interface module, in substantially straight trajectories, toward virtual keys on the virtual musical instrument;

6. The system of claim 5, wherein the game objects are collided with the corresponding keys according to the rhythmic pattern of the musical performance data, and wherein the first player module is awarded a value based upon the first player module striking the corresponding key on the musical performance module approximately simultaneously as the game object collides with the virtual keys.

7. The system of claim 6, wherein the graphical user interface module further comprises a series of visible staff lines, wherein the visible staff lines correspond to the substantially straight trajectories of the game objects, such that the game objects travel along the lines until the game objects collide with the corresponding virtual keys.

8. A computer readable storage medium comprising computer readable program code configured to execute on a processor for communicating musical data over a network, the program code configured to:
connect a first player module to a network;
provide an unassigned channel of prerecorded music data;
provide an assigned channel of prerecorded music data;
display the assigned channel;
play the unassigned channel while not playing the assigned channel;
convert musical performance to music performance data;
evaluate the music performance data in regard to the assigned channel; and
deliver a representation of the evaluation over the network.

9. The computer readable storage medium of claim 8, wherein the program code is further configured to evaluate music data, wherein evaluate music data includes:
record a performance channel; and
match units of the performance channel to units of the assigned channel.

10. The computer readable storage medium of claim 9, wherein the program code is further configured to display evaluation data associated with the first player module.

11. The computer readable storage medium of claim 9, wherein the program code is further configured to simultaneously visually display evaluation data associate with the first player module and evaluation data associated with a second player module during the first mode.

12. The computer readable storage medium of claim 8, wherein the program code is further configured to simultaneously playback a recorded performance data channel from the first player module and a performance data channel from a second player module.

13. The computer readable storage medium of claim 8, wherein the program code is further configured to:
generate a graphical user interface including a virtual instrument positioned substantially at a top portion of the graphical interface, wherein the virtual musical instrument includes a plurality of virtual keys, each key corresponding to a key on the performance module;
incorporate a music file into the graphical user interface, wherein the music file contains data corresponding to an arrangement of a plurality of musical notes in sequence, having a rhythmic pattern, each note being represented by a game object;
direct the game objects upward, in substantially straight trajectories, toward the virtual keys on the virtual musical instrument corresponding to the musical notes;
collide the game objects with the corresponding keys according to the rhythmic pattern of the arrangement; and
award a value to the first player module based upon the first player module striking a corresponding key on the musical performance module approximately simultaneously with the collisions.

14. The computer readable storage medium of claim 13, wherein the program code is further configured to introduce a series of visible staff lines defining spaces, where the lines and spaces correspond to the substantially straight trajectories along which the game objects travel toward the virtual musical instrument, such that the game objects travel along the visible staff lines until colliding with the virtual musical instrument at the corresponding virtual key.

15. A method for communicating musical data over a network, comprising:
connecting a first player module to a network;
providing an unassigned channel of prerecorded music data;
providing an assigned channel of prerecorded music data;
displaying the assigned channel;
playing the unassigned channel while not playing the assigned channel;
converting musical performance to music performance data;
evaluating the music performance data in regard to the assigned channel; and
delivering a representation of the evaluation over the network.

16. The method of claim 15, wherein evaluating the music performance data comprises:
recording a performance channel; and
matching units of the performance channel to units of the assigned channel.

17. The method of claim 15, further comprising visually displaying evaluation data associated with the first player module.

18. The method of claim 17, further comprising simultaneously visually displaying evaluation data associated with the first player module and evaluation data associated with a second player module during the first mode.

19. The method of claim 14, further comprising:
generating a graphical user interface, including a virtual instrument positioned substantially at a top portion of the graphical interface, wherein the virtual musical instrument includes a plurality of virtual keys, each key corresponding to a key on the performance module;
incorporating a music file into the graphical user interface, wherein the music file contains data corresponding to an arrangement of a plurality of musical notes in sequence, having a rhythmic pattern, each note being represented by a game object;
directing the game objects upward, in substantially straight trajectories, toward the virtual keys on the virtual musical instrument corresponding to the musical notes;
colliding the game objects with the corresponding keys according to the rhythmic pattern of the arrangement; and
awarding a value to the first player module based upon the first player module striking a corresponding key on the musical performance module approximately simultaneously with the collisions.

20. The method of claim 19, further comprising introducing a series of visible staff lines defining spaces, where the lines and spaces correspond to the substantially straight trajectories along which the game objects travel toward the virtual musical instrument, such that the game objects travel along the visible staff lines until colliding with the virtual musical instrument at the corresponding virtual key.
